(19) United States
(12) Patent Application Publication
(10) Pub. No.: US 2026/0303292 A1
(43) Pub. Date: Oct. 1, 2026

(54) TECHNIQUES FOR TIME DOMAIN MULTIPLEXED (TDM) DEMODULATION REFERENCE SIGNALS (DMRSS)

(71) Applicant: QUALCOMM Incorporated, San Diego, CA (US)

(72) Inventors: Syed Hashim Ali SHAH, Littleton, MA (US); Alberto RICO ALVARINO, San Diego, CA (US)

(21) Appl. No.: 19/576,758

(22) Filed: Mar. 24, 2026

Related U.S. Application Data
(60) Provisional application No. 63/779,986, filed on Mar. 28, 2025.

(51) Int. Cl. H04L 5/00

(52) U.S. Cl. CPC H04L 5/0051; H04L 5/0007

(57) ABSTRACT

This disclosure provides methods, components, devices and systems for techniques for multiplexing reference signals. For example, a time domain multiplexed (TDM) demodulation reference signal (DMRS) sequence design may support narrowband physical uplink shared channel (NPUSCH) transmissions with orthogonal cover codes (OCCs). A user equipment (UE) may transmit capability information indicating that the UE supports multiplexing with OCC. The network entity may provide a DMRS configuration to the UE (e.g., an OCC configuration including a multiplexing order and an OCC codeword, which may indicate which DMRSs to transmit and which DMRSs to null). The UE may generate a sequence of TDM DMRSs for transmission in accordance with the OCC configuration. The UE may skip DMRSs that are lost due to the TDM DMRS sequence and nulling. Alternatively, the UE may transmit at least some TDM DMRSs that would otherwise be lost due to the TDM DMRS sequence.

### CROSS REFERENCES

The present Application for Patent claims benefit of U.S. Provisional Patent Application No. 63/779,986 by SHAH et al., entitled “TECHNIQUES FOR TIME DOMAIN MULTIPLEXED (TDM) DEMODULATION REFERENCE SIGNALS (DMRSs),” filed Mar. 28, 2025, assigned to the assignee hereof, and expressly incorporated herein.

### TECHNICAL FIELD

This disclosure relates generally to wireless communication, and more specifically to systems, devices, methods, and techniques associated with techniques for time domain multiplexed (TDM) demodulation reference signals (DMRSs).

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

Some wireless communication systems may support multiplexing of uplink transmissions via the same resources using orthogonal cover codes (OCCs).

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include transmitting capability information indicating that the UE supports multiplexing of uplink transmissions with orthogonal cover codes (OCCs), receiving control signaling including an OCC configuration, the OCC configuration including a multiplexing order and a codeword for time domain multiplexed (TDM) demodulation reference signals (DMRSs), and transmitting a sequence of TDM DMRSs via a set of slots based on the multiplexing order and the codeword, where transmission of the sequence of TDM DMRSs includes nulling one or more TDM DMRS transmissions in a first subset of the set of slots, where the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence.

A UE for wireless communications is described. The UE may include a processing system that includes processor circuitry and memory circuitry that stores code. The processing system may be configured to cause the UE to transmit capability information indicating that the UE supports multiplexing of uplink transmissions with orthogonal cover codes (OCCs), receive control signaling including an OCC configuration, the OCC configuration including a multiplexing order and a codeword for time domain multiplexed (TDM) demodulation reference signals (DMRSs), and transmit a sequence of TDM DMRSs via a set of slots based on the multiplexing order and the codeword, where transmission of the sequence of TDM DMRSs includes nulling one or more TDM DMRS transmissions in a first subset of the set of slots, where the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence.

Another UE for wireless communications is described. The UE may include means for transmitting capability information indicating that the UE supports multiplexing of uplink transmissions with orthogonal cover codes (OCCs), means for receiving control signaling including an OCC configuration, the OCC configuration including a multiplexing order and a codeword for time domain multiplexed (TDM) demodulation reference signals (DMRSs), and means for transmitting a sequence of TDM DMRSs via a set of slots based on the multiplexing order and the codeword, where transmission of the sequence of TDM DMRSs includes nulling one or more TDM DMRS transmissions in a first subset of the set of slots, where the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence.

A non-transitory computer-readable medium storing code for wireless communications is described. The code may include instructions executable by one or more processors to transmit capability information indicating that the UE supports multiplexing of uplink transmissions with orthogonal cover codes (OCCs), receive control signaling including an OCC configuration, the OCC configuration including a multiplexing order and a codeword for time domain multiplexed (TDM) demodulation reference signals (DMRSs), and transmit a sequence of TDM DMRSs via a set of slots based on the multiplexing order and the codeword, where transmission of the sequence of TDM DMRSs includes nulling one or more TDM DMRS transmissions in a first subset of the set of slots, where the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence.

Some examples of the method, user equipment (UEs), and non-transitory computer-readable medium described herein may further include operations, features, means, or instructions for identifying a set of multiple input values for the sequence, each input value corresponding to a respective slot of a set of multiple slots including the first subset of slots and the second subset of slots and transmitting a second subset of DMRSs via the second subset of slots in accordance with the sequence, the second subset of DMRSs based on a first portion of the set of multiple input values corresponding to the second subset of slots, where skipping the subset of DMRSs corresponding to the first subset of slots includes refraining from transmitting the subset of DMRSs that may be based on a second portion of the set of multiple input values corresponding to the first subset of slots.

Some examples of the method, user equipment (UEs), and non-transitory computer-readable medium described herein may further include operations, features, means, or instructions for identifying a set of multiple input values for the sequence, each input value corresponding to a respective slot of a set of multiple slots including the first subset of slots and the second subset of slots, generating a first DMRS of the subset of DMRSs corresponding to the first subset of slots using a first input value corresponding to a first slot of the first subset of slots, and transmitting the first DMRS corresponding to the first input value via a next available slot of the second subset of slots based on nulling the first slot of the first subset of slots.

Some examples of the method, user equipment (UEs), and non-transitory computer-readable medium described herein may further include operations, features, means, or instructions for generating the sequence of TDM DMRSs for the first subset of slots and the second subset of slots based on a defined sequence generation pattern, the codeword, and the multiplexing order.

Some examples of the method, user equipment (UEs), and non-transitory computer-readable medium described herein may further include operations, features, means, or instructions for selecting the first subset of slots for transmission of the sequence of TDM DMRSs and the second subset of slots for transmission of the sequence of TDM DMRSs in accordance with the codeword.

### BRIEF DESCRIPTION OF THE DRAWINGS

FIG. 1 shows an example of a wireless communication system.

FIG. 2 shows an example of a signaling configuration that supports techniques for time domain multiplexed (TDM) demodulation reference signals (DMRSs).

FIG. 3 shows an example of a transmission scheme that supports techniques for TDM DMRSs.

FIG. 4 shows an example of a timeline that supports techniques for TDM DMRSs.

FIG. 5 shows an example of a timeline that supports techniques for TDM DMRSs.

FIG. 6 shows an example of a timeline that supports techniques for TDM DMRSs.

FIG. 7 shows an example of a timeline that supports techniques for TDM

DMRSs.

FIG. 8 shows an example of a timeline that supports techniques for TDM DMRSs.

FIG. 9 shows an example of a process flow that supports techniques for TDM DMRSs.

FIG. 10 shows a block diagram of a processing system that supports techniques for TDM DMRSs.

FIG. 11 shows a diagram of a system including a device that supports techniques for TDM DMRSs.

FIGS. 12 through 14 show flowcharts illustrating methods that support techniques for TDM DMRSs.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including fourth generation (4G), fifth generation (5G), or sixth generation (6G) communications systems, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, such as in a narrowband internet of things (NB IoT) system, a user equipment (UE) may transmit multiple uplink transmissions (e.g., multiple coded copies of data, repetitions of data, reference signals such as demodulation reference signals (DMRSs), etc.). To increase uplink capacity, multiple UEs may simultaneously access resources using a non-orthogonal multiple access (NOMA) deployment, in which data from the multiple UEs is identified at a network entity of the network. In NOMA scenarios, the simultaneous transmissions from the multiple UEs may cause uplink interference at the network entity. Moreover, identifying the data at the network entity as coming from particular UEs may be complex and time consuming. For example, identifying data from respective UEs may involve the UEs employing complex and robust scrambling schemes and complex receiver (e.g., at the base station) design.

Some UEs may support orthogonal cover codes (OCCs). OCCs may refer to spreading sequences applied to reference signals or data transmissions across multiple symbols or antenna ports, whereby the orthogonality between codes ensures that signals multiplexed in the same time-frequency resources can be separated at a receiver device. In some examples, OCCs may be used to increase the capacity of reference signal transmission by allowing multiple layers or ports to share the same physical resources while remaining distinguishable through code-domain multiplexing.

Accordingly, as described herein, transmitting UEs may use an orthogonal cover code (OCC) to enable orthogonal M order UE multiplexing without robust scrambling and/or complex receiver design at the network entity. If the total quantity or repetitions is more than 2M, the UEs apply the M factor cover coding without increasing the amount of time-frequency resources used for the uplink transmissions. Accordingly, uplink capacity (in terms of the quantity of UEs that can be scheduled in a given time-frequency resource, with almost no interference among the UEs) is increased from the network perspective. However, if a robust DMRS sequence design is not enabled to support systems with OCC multiplexing, wireless communication systems leveraging OCC multiplexing may experience decreased efficiency. For example, some DMRS systems may not support multiplexed DMRS transmissions by multiple UEs. Such inefficient DMRS designs for OCC systems may lead to degradation in channel estimation performance, and may result in performance degradation, which may in turn translate to compromise on the capacity gains offered by the OCC scenario. In some cases, as described herein, one UE may transmit DMRS transmissions while other UEs refrain from transmitting DMRSs (e.g., nulling transmission of one or more DMRSs during some DMRS symbols). However, without defined DMRS sequences for such OCC systems, UEs and network entities may not accurately or consistently transmit DMRSs.

Aspects of the subject matter described in this disclosure relate to robust DMRS sequence design supporting OCC for multiplexing multiple UEs. As described herein, a robust DMRS sequence design may include time domain multiplexed (TDM) DMRS sequences. Such a TDM DMRS sequence design may support narrowband physical uplink shared channel (NPUSCH) transmissions with OCC (e.g., for NPUSCH transmission with OCC over narrowband internet of things (NB-IoT). A UE (e.g., a NB-IoT UE) may transmit capability information indicating that the UE supports multiplexing with OCC. The network entity (e.g., an NTN network entity) may provide a DMRS configuration to the UE (e.g., an OCC configuration including a multiplexing order M and an OCC codeword m, which may indicate which DMRSs to transmit and which DMRSs to null). The UE may generate a sequence of TDM DMRSs for transmission in accordance with the OCC configuration. According to techniques described herein, the UE may transmit TDM DMRSs via a set of DMRS symbols (e.g., one DMRS symbol in each slot). The UE may skip DMRSs that are lost due to the TDM DMRS sequence. For example, the UE may transmit TDM DMRSs via first, second, fifth and sixth DMRS symbols of first, second, fifth and sixth slots, and may null third and fourth DMRS symbols of third and fourth slots. The UE may simply skip (e.g., refrain from transmitting) third and fourth TDM DMRSs corresponding to the nulled third and fourth DMRS symbols. In some examples, according to techniques described herein, the UE may transmit at least some TDM DMRSs that would otherwise be lost due to the TDM DMRS sequence. For example, the UE may transmit TDM DMRSs via first, second, fifth and sixth DMRS symbols of first, second, fifth and sixth slots, and may null third and fourth DMRS symbols of third and fourth slots. The UE may transmit the TDM DMRSs corresponding to the nulled third and fourth DMRS symbols via the fifth and sixth DMRS symbols, respectively (e.g., instead of skipping the missed third and fourth TDM DMRSs).

Particular aspects of the subject matter described in this disclosure can be implemented to realize one or more of the following potential advantages. In some examples, by transmitting TDM DMRSs in accordance with the TDM DMRS sequence design (e.g., skipping missed TDM DMRSs, or not skipping the TDM DMRSs missed by the TDM DMRS sequence), the described techniques can be used to more efficiently utilize available system resources (e.g., by supporting transmission of DMRSs by multiple UEs), and improved channel estimation. Further, DMRS transmission in accordance with techniques described herein may allow for accurate and efficient channel estimation without the cost of additional scrambling procedures. Additionally, or alternatively, TDM DMRS transmissions without clear TDM DMRS sequence design as described herein may result in failed channel estimation, inability to support OCC deployments, less efficient use of resources, etc. Techniques described herein therefore support more effective channel estimation, more efficient use of system resources, increased reliability of channel estimation, increased throughput, decreased system latency, and improved user experience.

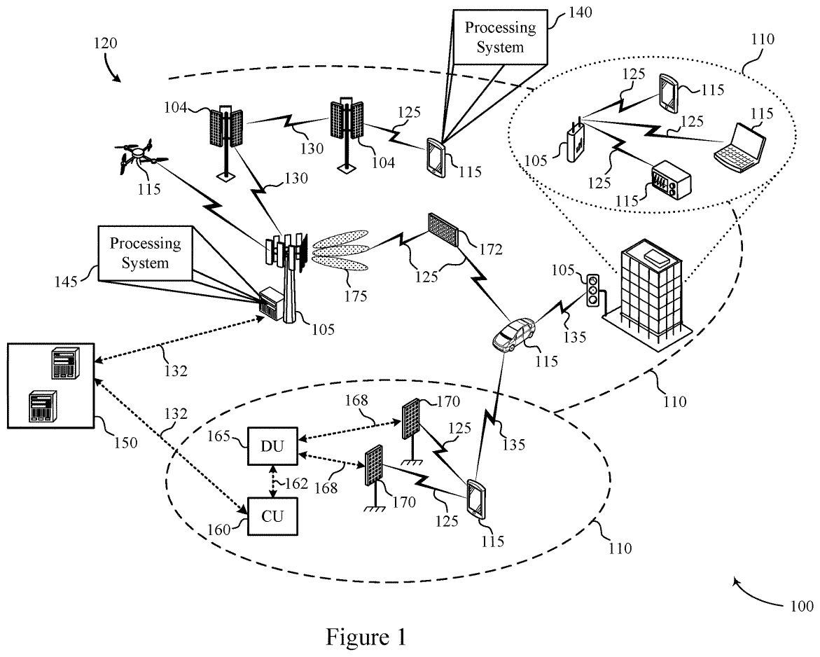

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for TDM DMRSs. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support improved channel estimation, improved throughput, and more efficient use of available system resources.

Aspects of the subject matter described in this disclosure relate to robust DMRS sequence design supporting OCC for multiplexing multiple UEs. As described herein, a robust DMRS sequence design may include time domain multiplexed (TDM) DMRS sequences. Such a TDM DMRS sequence design may support narrowband physical uplink shared channel (NPUSCH) transmissions with OCC (e.g., for NPUSCH transmission with OCC over narrowband internet of things (NB-IoT). A UE (e.g., a NB-IoT UE) may transmit capability information indicating that the UE supports multiplexing with OCC. The network entity (e.g., an NTN network entity) may provide a DMRS configuration to the UE (e.g., an OCC configuration including a multiplexing order M and an OCC codeword m, which may indicate which DMRSs to transmit and which DMRSs to null). The UE may generate a sequence of TDM DMRSs for transmission in accordance with the OCC configuration. According to techniques described herein, the UE may transmit TDM DMRSs via a set of DMRS symbols (e.g., one DMRS symbol in each slot). The UE may skip DMRSs that are lost due to the TDM DMRS sequence. For example, the UE may transmit TDM DMRSs via first, second, fifth and sixth DMRS symbols of first, second, fifth and sixth slots, and may null third and fourth DMRS symbols of third and fourth slots. The UE may simply skip (e.g., refrain from transmitting) third and fourth TDM DMRSs corresponding to the nulled third and fourth DMRS symbols. In some examples, according to techniques described herein, the UE may transmit at least some TDM DMRSs that would otherwise be lost due to the TDM DMRS sequence. For example, the UE may transmit TDM DMRSs via first, second, fifth and sixth DMRS symbols of first, second, fifth and sixth slots, and may null third and fourth DMRS symbols of third and fourth slots. The UE may transmit the TDM DMRSs corresponding to the nulled third and fourth DMRS symbols via the fifth and sixth DMRS symbols, respectively (e.g., instead of skipping the missed third and fourth TDM DMRSs).

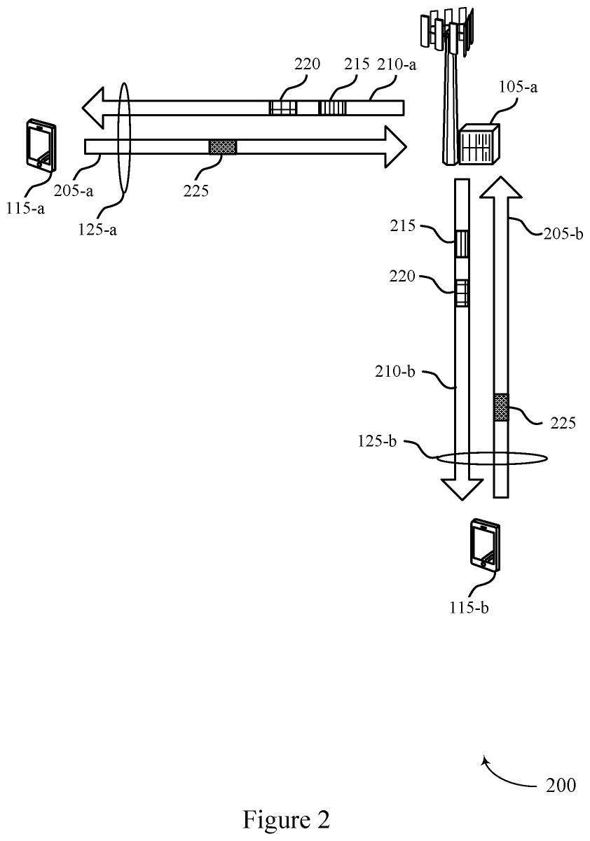

FIG. 2 shows an example of a signaling configuration 200 that supports techniques for TDM DMRSs. The signaling configuration 200 may implement, or be implemented by, aspects of the wireless communication systems 100. For example, the signaling configuration 200 may include a network entity 105-a (e.g., which may be an example of a terrestrial network (TN) or an NTN network entity), and one or more UEs 115 (e.g., the UE 115-a and the UE 115-b), which may be examples of corresponding devices described with reference to FIG. 1.

In some examples, the UE 115-a and/or the UE 115-b may be NB IoT devices. To ensure reliable communications where the UE 115-a and/or the UE 115-b are NB IoT devices, the UE 115-a and/or the UE 115-b may transmit multiple coded transmissions (e.g., DMRSs, or repetitions of data). The transmissions may be used as a method or dimension to multiplex multiple uplink transmission from the UE 115-a and the UE 115-b to facilitate increasing uplink capacity (e.g., packing transmissions from multiple UEs 115 into the same time-frequency resources). The multiple UEs 115 may send transmissions via the same time and frequency resources. However, multiplexing multiple UEs 115 may create interference at the network entity 105-a. As discussed herein, an orthogonal cover coding configuration may mitigate the potential interference. In particular, the data from the UEs 115 may be cover coded across transmissions in an orthogonal manner. In some cases, the multiple UEs 115 (e.g., the UE 115-a and/or the UE 115-b) may use orthogonal demodulation reference signals (DMRSs) which use their own OCC.

The UE 115-a may communicate with the network entity 105-a using a communication link 125-a, and the UE 115-b may communicate with the network entity 105-a using a communication link 125-b. The communication link 125-a may be an example of an NR or LTE link between the UE 115-a and the network entity 105-a. The communication link 125-b may be an example of an NR or LTE link between the UE 115-b and the network entity 105-a. In some examples, the communication link 125-a and/or the communication link 125-b may be examples of a non-terrestrial network (NTN) link. The communication link 125-a and the communication link 125-b may include bi-directional links that enable both uplink and downlink communications. For example, the UE 115-a may transmit the uplink signals 205-a (e.g., uplink transmissions), such as uplink control signals, capability information, DMRSs, or uplink data signals, to the network entity 105-a using the communication link 125-a and the network entity 105-a may transmit downlink signals 210-a (e.g., downlink transmissions), such as downlink control signals or downlink data signals, to the UE 115-a using the communication link 125-a. The UE 115-b may transmit uplink signals 205-b (e.g., uplink transmissions), such as uplink control signals, capability information, DMRSs, or uplink data signals, to the network entity 105-a using the communication link 125-b and the network entity 105-a may transmit downlink signals 210-b (e.g., downlink transmissions), such as downlink control signals or downlink data signals, to the UE 115-b using the communication link 125-b.

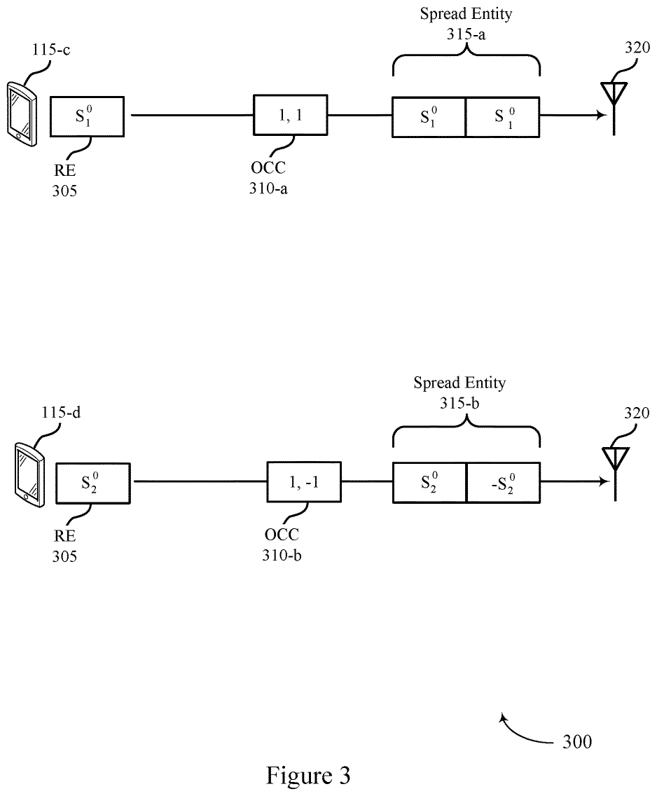

To mitigate interference caused by uplink transmissions by the UEs 115 over the same time-frequency resources, the network entity 105-a may transmit control signaling 215 to the UEs 115 indicating an M factor orthogonal cover coding configuration to apply to uplink grants of DMRSs for the UEs that will be multiplexed in the same time-frequency resources. For example, the network entity 105-a may transmit second control signaling 220 that configures transmissions 225 (e.g., DMRSs) for the UE 115-a and the UE 115-b in the same time-frequency resources. The control signaling 215 may indicate a repetition configuration, a respective orthogonal cover coding configuration (e.g., a modulation order and an OCC codeword) to be applied to the uplink transmissions (e.g., DMRSs) for the respective UEs 115. The UE may transmit TDM DMRSs according to a defined TDM DMRS sequence in OCC scenarios as described in greater detail herein with reference to FIGS. 3-9. Such OCC scenarios are described in greater detail with reference to FIG. 3.

FIG. 3 shows an example of a transmission scheme 300 that supports techniques for TDM DMRSs. The transmission scheme 300 may implement, or be implemented by, aspects of the wireless communication systems 100 and the signaling configuration 200. For example, the UE 115-c and the UE 115-d and a network entity (e.g., a network entity 105), which may be examples of corresponding devices described with reference to FIGS. 1-2, may communicate with each other in accordance with the transmission scheme 300.

Multiple access schemes, such as the transmission scheme 300, may be utilized to multiplex transmissions by multiple UEs 115, hence increasing capacity (e.g., packing more transmissions by UEs 115 in a same amount of time-frequency resources, resulting in more efficient use of system resources). Multiplexing the multiple UEs may result in interference at a network entity, as described in greater detail with reference to FIG. 2. OCCs may mitigate such interference. In such examples, data from multiple UEs 115 may be cover coded across repetitions in an orthogonal manner using an OCC. The repetitious nature of the uplink transmission (e.g., including DMRSs) may result in lower cost multiplexing (e.g., instead of code division multiple access (CDMA), which may correspond to a higher cost at the network entity 105, the UEs 115, or both).

OCC may increase the duration of transmitted signals by a multiplexing factor M, where M may represent a quantity of UEs 115 being multiplexed. For instance, the UE 115-c and the UE 115-d may both transmit on the same RE 305. The RE 305 may be represented by an

$${REs}_{i}^{j}$$

(RE j at a UE i). Thus, in the case of two UEs 115 (e.g., M=2), the UE 115-c (e.g., the UE i=1) may transmit via the RE 305 (e.g., the

$${REs}_{1}^{0} )$$

and the UE 115-d (e.g., the UE i=2) may transmit via the RE 305 (e.g., the

$${REs}_{2}^{0} ) .$$

The UEs 115 may apply an OCC 310. For example, the UE 115-c may apply an OCC 310-a (e.g., [1,1]), and the UE 115-d may apply an OCC 310-b (e.g., [1,−1]). The UEs 115 may apply a spreading function (e.g., a spread entity 315) based on the OCC. For example, the spread entity 315-a

$$( e . g . , {s}_{1}^{0} , {s}_{1}^{0} )$$

may be based on the OCC 310-a, and the spread entity 315-b

$$( e . g . , {s}_{1}^{0} , - {s}_{1}^{0} )$$

may be based on the OCC 310-b. In some examples, the OCC may increase the duration of the transmitted signals by the multiplexing factor M. For example, for M=2, the transmission for the RE 305 may result in a two-RE transmission due to the spread entities 315 based on the OCCs 310.

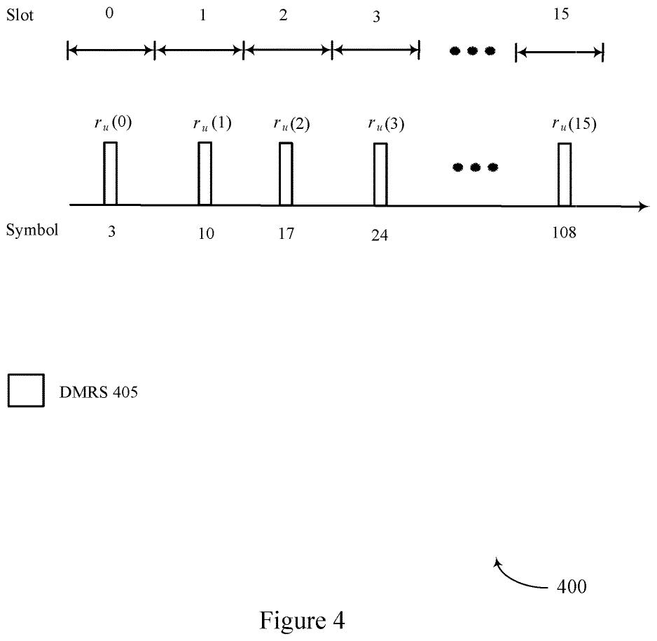

In some examples, as described herein, a UE 115 may transmit DMRSs (e.g., via one or more antennas 320) in an OCC deployment. The UE 115 may report capability information indicating that the UE 115 supports multiplexing with OCC, and the network entity may configure the UE with an OCC configuration (e.g., that consists of at least the multiplexing order (e.g., an OCC factor), and an OCC codeword. The UE 115 may transmit TDM DMRSs in accordance with the OCC configuration, and one or more rules described herein. DMRS sequences are described in greater detail with reference to FIG. 4.

FIG. 4 shows an example of a timeline 400 that supports techniques for TDM DMRSs. The timeline 400 may implement, or be implemented by, aspects of the wireless communication systems 100, the signaling configuration 200, or the transmission scheme 300. For example, a UE (e.g., a UE 115) and a network entity (e.g., a network entity 105), which may be examples of corresponding devices described with reference to FIGS. 1-3, may communicate with each other in accordance with the timeline 400.

In some examples, a wireless communications system may support multiplexing of multiple UEs for some wireless channels (e.g., a 3.75 kHz or 15 kHz subcarrier) via OCCs for uplink channels (e.g., NPUSCH format 1 and NPRACH). Such multiplexing may be supported on multi-tone support for 15 kHz subcarrier spacing (SCS), among other examples. In some examples, for a 3.75 kHz SCS OCC for NPUSCH format 1, the wireless communications system may support TDM DMRSs over multiple slots (e.g., four slots) where DMRS are transmitted in the first two slots, and DMRS REs are blanked (e.g., nulled) in the next two slots, or vice versa. DMRS REs may be defined, and a guard period within the slot may be included.

OCC may be supported in NB-IoT NTN uplink and may result in capacity gains. To exploit such capacity gains, techniques described herein may support a robust DMRS design to support OCC transmission. DMRS sequences are described herein to support TDM DMRS transmissions in OCC scenarios.

For uplink NB-IoT single subcarrier

$$( e . g . , {N}_{sc}^{RU} = 1 )$$

case, DMRSs 405 may occur in DMRS symbols (e.g., every 7 symbols, one DMRS symbol in each slot). For instance, one resource unit (RU) may include 16 slots, and may therefore also include 16 DMRS symbols (e.g., a DMRS 405 may occur in symbol 3 of slot 0, symbol 10 of slot 1, symbol 17 of slot 2, symbol 24 of slot 3, etc., up to symbol 108 of slot 16). In some examples, the duration of each slot may be 0.5 ms for a 15 kHz subcarrier, or 2 ms for a 3.75 kHz subcarrier. The duration of an RU may be 8 ms for a 15 kHz subcarrier, and 32 ms for a 3.75 kHz subcarrier.

DMRSs may be defined by, for example, a Gold sequence (e.g., 1-2c(n)) on top of an OCC sequence (e.g., a length 16 Hadamard sequence, such as w(n mod 16). The Hadamard sequence may be orthogonal amongst (e.g., across) cells, such that UEs using different cells may use orthogonal sequences. In some examples, a DMRS sequence rᵤ(n) may be defined as

$${r}_{u} ( n ) = \frac{1}{\sqrt{2}} ( 1 - 2 c ( n ) )$$

w(n mod 16) where

$$0 \leq n \leq {M}_{rep}^{NPUSCH} {N}_{slots}^{UL} {N}_{RU} , and where {M}_{rep}^{NPUSCH}$$

represents a quantity of repetitions on the NPUSCH,

$${N}_{slots}^{UL}$$

represents a quantity of uplink slots, and NRU represents a quantity of RUs.

In some examples, the wireless communications system may support TDM DMRSs (e.g., for NPUSCH with OCC). Such TDM DMRSs may be supported for a single carrier of 3.75 kHz, for example. For instance,

$$( e . g . , u = {N}_{ID}^{cell} mod 16 ) ,$$

may represent a transmitted DMRS symbol at slot number n, cell (e.g., beam) u

$${s}_{u}^{m} ( n )$$

and a UE m. The OCC factor (e.g., the multiplexing order or quantity of UEs to be multiplexed) may be represented by M. In such examples, a DMRS sequence (e.g., such as a TDM DMRS) may be represented as rᵤ(n)=x[n]wᵤ(n mod 16), where

$$0 \leq n \leq {M}_{rep}^{pusch} {N}_{slots}^{UL} {N}_{RU} and x [ n ] = \frac{1}{√ 2} ( 1 + j ) ( 1 - 2 c [ n ] ) .$$

In such examples, one UE may transmit during some DMRS symbols (e.g., while another UE nulls DMRS transmissions via those DMRS symbols), and may then null one or more DMRS symbols (e.g., while another UE transmits DMRS signaling during nulled one or more DMRS symbols). However, if the UEs and the network entity do not adhere to a defined TDM DMRS sequence regarding how to deal with lost DMRSs (e.g., from the nulled DMRS symbols), DMRSs may fail, or channel estimation may be degraded, among other examples. A cell ID u (e.g., of the OCC sequence) may be defined in a table (e.g., a lookup table), such that w(n mod 16) is indicated as w(0), . . . , w(15), where each row in the lookup table corresponds to a cell ID u.

As described herein, a TDM DMRS sequence

$${s}_{u}^{m} ( n )$$

may be defined. The TDM DMRS sequence

$${s}_{u}^{m} ( n )$$

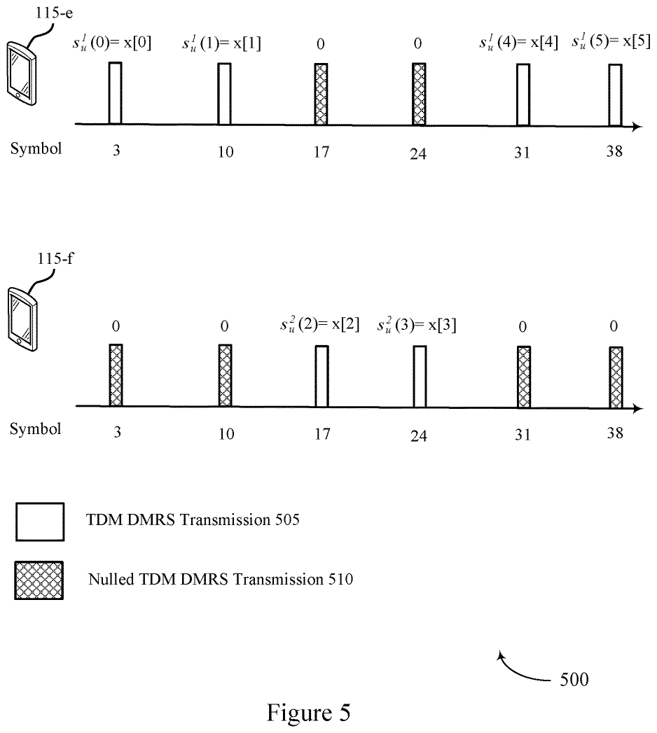

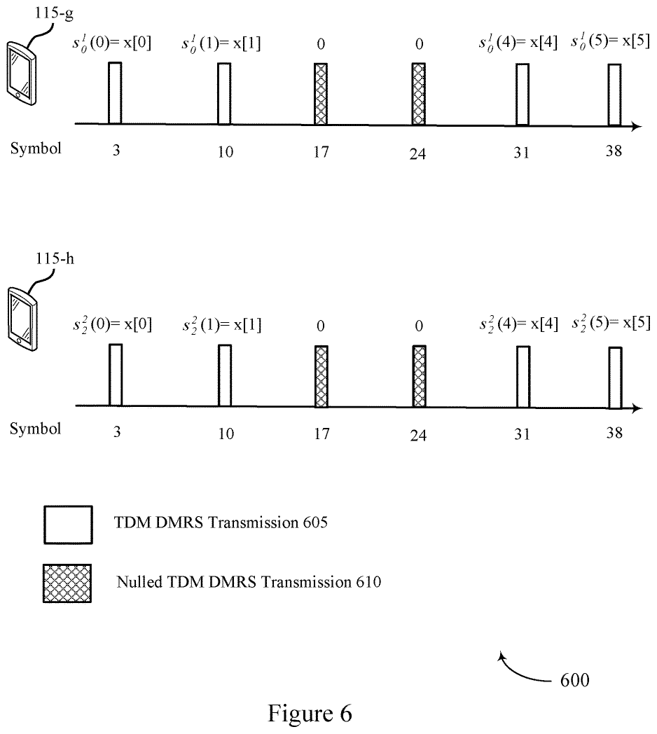

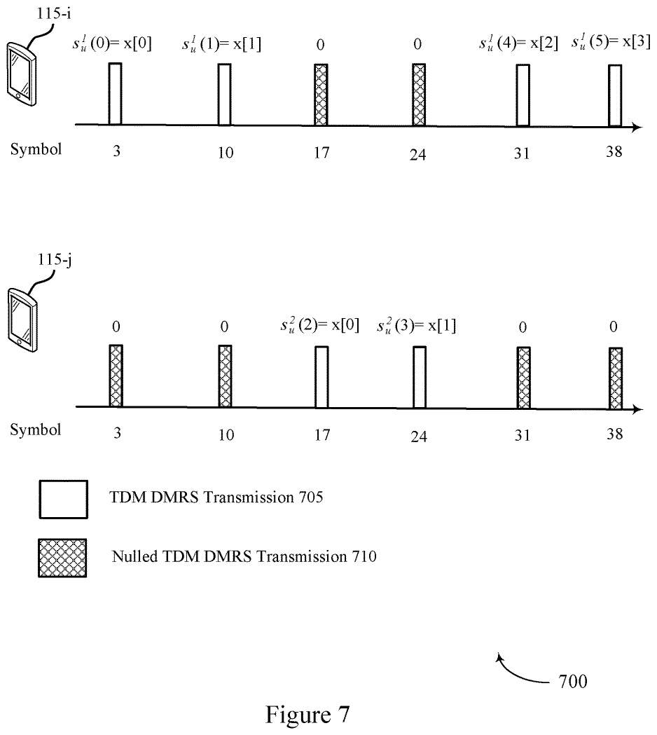

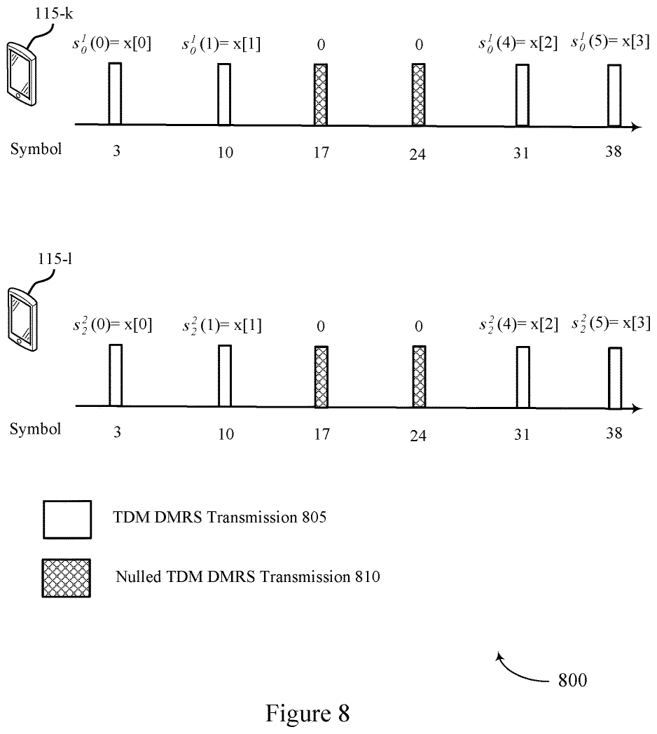

may be defined for NPUSCH with OCC. In some examples, as described in greater detail with reference to FIGS. 5 and 6, a UE may skip one or more TDM DMRSs lost (e.g., during null DMRS symbols). As described in greater detail with reference to FIGS. 7 and 8, a UE may not skip the one or more TDM DMRSs lost due to the nulling, and may instead transmit such TDM DMRSs via next available (e.g., not nulled) DMRS symbols.

FIG. 5 shows an example of a timeline 500 that supports techniques for TDM DMRSs. The timeline 500 may implement, or be implemented by, aspects of the wireless communication systems 100, the signaling configuration 200, the transmission scheme 300, or the timeline 400. For example, the UE 115-e and the UE 115-f and a network entity (e.g., a network entity 105), which may be examples of corresponding devices described with reference to FIGS. 1-4, may communicate with each other in accordance with the timeline 500. The UE 115-e and the UE 115-f may both communicate via the same cell (e.g., cell 0). The UE 115-e and the UE 115-f may multiplex DMRS transmissions (e.g., via the same DMRS symbols) by using OCC and in accordance with a TDM DMRS sequence, as described herein.

In some examples, the UE 115-e and the UE 115-f may skip TDM DMRSs lost due to the TDM transmission scheme. For example, the UEs 115 may transmit TDM DMRSs in accordance with a TDM DMRS sequence

$${s}_{u}^{m} ( n ) ,$$

wherein TDM DMRSs are transmitted via DMRS symbols at slot number n, and via cell (e.g., beam) u (e.g., where u=N_{ID}^{cell}mod 16) and a UE m (e.g., where m goes from 0 to M−1). An OCC factor (e.g., a multiplexing order or a quantity of UEs 115 to be multiplexed) may be defined as M. For example, for the UE 115-e and the UE 115-f, M=2. The UEs 115 may transmit TDM DMRSs in accordance with a TDM DMRS sequence

$${s}_{u}^{m} ( n ) = ( x [ n ] {w}_{u} [ n mod 16 ] )$$

( [symbol] {(n mod 2M)<M} ⊕m), where the TDM aspect of the TDM DMRS sequence is generated in accordance with the term ( [symbol] {(n mod 2M)<M}⊕m).

Each UE 115 may be configured with an OCC configuration, which may include an indication of the multiplexing order M and an OCC codeword. In some examples, an OCC configuration may correspond to or indicate one or more OCC codewords. An OCC codeword may refer to a specific sequence of orthogonal spreading coefficients (e.g., which may be represented as a vector of +1 and −1 values (e.g., [+1, +1] or [+1, −1])) that may be applied across a set of symbols or ports to distinguish one multiplexed signal from another. Each codeword in an OCC set may be orthogonal to all other codewords in the set, such that an inner product of a codeword is zero, thereby enabling interference-free separation of co-resource transmissions at the receiver. The OCC configuration may indicate a pattern for DMRS transmission and DMRS nulling (e.g., a pattern of TDM DMRS transmissions 505 and nulled TDM DMRS transmissions 510). For example, the UE 115-e may be configured with a first codeword indicating that the UE 115-e is to transmit a sequence of TDM DMRSs via a set of slots (e.g., via DMRS symbol 3 and DMRS symbol 10 during a first slot and a second slot, and via DMRS symbol 31 and DMRS symbol 38 during fifth and sixth slots, etc.), and that the UE 115-e is to null DMRS transmissions during a first subset of the set of slots (e.g., that the UE 115-e is to refrain from transmitting TDM DMRSs via the DMRS symbol 17 and the DMRS symbol 24 during the third and fourth slots, respectively). Similarly, the UE 115-f may be configured with a second codeword indicating that the UE 115-f is to transmit a sequence of TDM DMRSs via a second subset of slots of the set of slots (e.g., via the DMRS symbol 17 and the DMRS symbol 24 during third and fourth slots, respectively), and that the UE 115-fis to null DMRS transmissions during a first subset of the set of slots (e.g., that the UE 115-f is to refrain from transmitting TDM DMRSs via the DMRS symbol 3, the DMRS symbol 10, the DMRS symbol 31, and the DMRS symbol 38 during the first, second, fifth, and sixth slots, respectively).

The UE may generate TDM DMRS transmissions in accordance with the TDM DMRS sequence

$${s}_{u}^{m} ( n ) ,$$

where a TDM DMRS (e.g., corresponding to x[n]) is based at least in part on an input value (e.g., a u value corresponding to a cell ID for wᵤ[n]). For example, a lookup table may define a set of values for w(n) (e.g., w(0), . . . , w(15)) based on a set of input values (e.g., cell ID u=0 through u=15). The input values may map to DMRS symbols in accordance with the TDM DMRS sequence.

In some examples, each UE may skip TDM DMRSs lost due to the TDM DMRS sequence. For example, the UE 115-e may transmit a first TDM DMRS (e.g., corresponding to

$${s}_{u}^{1} ( 0 ) = x [ 0 ] )$$

and a second TDM DMRS (e.g., corresponding to

$${s}_{u}^{1} ( 1 ) = x [ 1 ] ) .$$

The UL 115-e may null transmission during a next subset of DMRS symbols (e.g., may null DMRS transmission during the DMRS symbol 17 and the DMRS symbol 24). During a next available DMRS symbol 31 (e.g. for which the UE 115-e is not to null the DMRS transmission), the UE may simply transmit the corresponding TDM DMRS (e.g., corresponding to

$${s}_{u}^{1} ( 4 ) = x [ 4 ] )$$

during the corresponding DMRS symbol 31 (e.g., and may similarly transmit the TDM DMRS corresponding to

$${s}_{u}^{1} ( 5 ) = x [ 5 ]$$

during the DIVERS symbol 38). The UE 115-e may skip (e.g., may refrain from transmitting) the TDM DMRSs corresponding to

$${s}_{u}^{2} ( 2 ) = x [ 2 ] and {s}_{u}^{2} ( 3 ) = x [ 3 ]$$

(e.g., the nulled TDM DMRS transmissions 510). Similarly, the UE 115-f may skip TDM DMRSs corresponding to the DMRS symbol 3 and the DMRS symbol 10, and may transmit the next TDM DMRSs in the next available DMRS symbols (e.g., the UE 115-f may transmit the TDM DMRSs corresponding to

$${s}_{u}^{2} ( 2 ) = x [ 2 ] and {s}_{u}^{2} ( 3 ) = x [ 3 ]$$

via the DMRS symbols 17 and 24, respectively). The UE 115-f may not transmit (e.g., may skip) the TDM DMRSs corresponding to nulled TDM DMRS transmissions 510.

In some examples, UEs 115 may perform TDM DMRS with OCC via the same cell (e.g., as described with reference to FIG. 5) or different cells (e.g., as described in greater detail with reference to FIG. 6). In some examples, skipped TDM DMRSs may be transmitted via next available (e.g., non-nulled) DMRS symbols, as described in greater detail with reference to FIGS. 7 and 8.

FIG. 6 shows an example of a timeline 600 that supports techniques for TDM DMRSs. The timeline 600 may implement, or be implemented by, aspects of the wireless communication systems 100, the signaling configuration 200, the transmission scheme 300, the timeline 400, or the timeline 500. For example, the UE 115-g and the UE 115-h and a network entity (e.g., a network entity 105), which may be examples of corresponding devices described with reference to FIGS. 1-5, may communicate with each other in accordance with the timeline 600. The UE 115-g and the UE 115-h may both communicate via a different cell (e.g., the UE 115-g may communicate with a first cell 0 and the UE 115-h may communicate with a different cell such as cell 2). The UE 115-g and the UE 115-h may multiplex DMRS transmissions (e.g., via the same DMRS symbols) by using OCC and in accordance with a TDM DMRS sequence, as described herein.

In some examples, the UEs 115 may transmit TDM DMRSs in accordance with a TDM DMRS sequence

$${s}_{u}^{m} ( n ) ,$$

wherein TDM DMRSs are transmitted via DMRS symbols at slot number n, and via cell (e.g., beam) u (e.g., where u=N_{ID}^{cell}mod 16) and a UE m (e.g., where m goes from 0 to M−1). An OCC factor (e.g., a multiplexing order or a quantity of UEs 115 to be multiplexed) may be defined as M. For example, for the UE 115-g and the UE 115-h, M=2.

In some examples, the UE 115-g and the UE 115-g may use different TDM patterns (e.g., as described in greater detail with reference to FIG. 5, where techniques described with reference to a single cell may also be applied for multiple cells). In some examples, as illustrated with reference to FIG. 6, the UEs 115 may use the same TDM pattern (e.g., may be configured, via control signaling, with the same OCC index value or the same OCC codeword). In such examples, both the UEs 115 may send the same signal. In some examples, the transmissions may not be exactly aligned in time, in which case the timing difference across the different UEs (e.g., if different UEs 115 are scheduled to transmit via different slots, then an underlying Gold sequence generated depending on the slot of transmission and the misaligned starting slots for the UEs 115 may create two uncorrelated Gold sequences, resulting in pseudo-random interference cancellation). This misaligned transmission timing may reduce or mitigate interference at the network entity 105.

In some examples, if the signals are closely or exactly aligned in time, then DMRSs transmitted by the UEs 115 may interfere with each other, resulting in corrupted DMRSs. In such examples, the UEs 115 may generate the DMRS sequence using an underlying sequence (e.g., an underlying Gold sequence) which may depend on the cell ID. For example, if the transmitted DMRS signals are aligned in time, then the UE 115-h may generate the DMRS sequence using an underlying sequence that is based on the cell ID for the cell 0, and the UE 115-g may generate the DMRS sequence using an underlying sequence that is based on the cell ID for the cell 2, in which case the resulting DMRS sequences transmitted by the respective UEs 115 may be different, resulting in reduced or mitigated interference at the network entity 105. If the DMRS signals are not aligned, the transmitted sequence may be pseudo-random, and interference cancellation may be performed (e.g., based on the underlying Gold sequences).

As described in greater detail with reference to FIG. 5, the UEs 115 may send TDM DMRS transmissions 605 in accordance with the TDM DMRS sequence, and may skip TDM DMRSs corresponding to nulled TDM DMRS transmissions 610. For example, the UE 115-g may refrain from transmitting any nulled TDM DMRSs, such as the nulled TDM DMRS transmission 610 corresponding to

$${s}_{0}^{1} ( 2 ) = x [ 2 ] ,$$

and the nulled TDM DMRS transmission 610 corresponding to

$${s}_{0}^{1} ( 3 ) = x [ 3 ] .$$

In a next available (e.g., non-nulled) DMRS symbol 17, the UE 115-g may transmit a TDM DMRS corresponding to

$${s}_{0}^{1} ( 4 ) = x [ 4 ] .$$

Similarly, the UE 115-h may refrain from transmitting any nulled TDM DMRSs, such as the nulled TDM DMRS transmission 610 corresponding to

$${s}_{2}^{2} ( 2 ) = x [ 2 ] ,$$

and the nulled TDM DMRS transmission 610 corresponding to

$${s}_{2}^{2} ( 3 ) = x [ 3 ] .$$

In a next available (e.g., non-nulled) DMRS symbol 17, the UE 115-h may transmit a TDM DMRS corresponding to

$${s}_{2}^{2} ( 4 ) = x [ 4 ] .$$

In some examples, as described in greater detail, with reference to FIGS. 7 and 8, the UEs 115 may not skip TDM DMRSs that would otherwise be lost due to the nulled TDM DMRS transmissions 610.

FIG. 7 shows an example of a timeline 700 that supports techniques for TDM DMRSs. The timeline 700 may implement, or be implemented by, aspects of the wireless communication systems 100, the signaling configuration 200, the transmission scheme 300, the timeline 400, the timeline 500, or the timeline 600. For example, the UE 115-i and the UE 115-j and a network entity (e.g., a network entity 105), which may be examples of corresponding devices described with reference to FIGS. 1-6, may communicate with each other in accordance with the timeline 700. The UE 115-i and the UE 115-j may both communicate via the same cell (e.g., cell 0). The UE 115-i and the UE 115-j may multiplex DMRS transmissions (e.g., via the same DMRS symbols) by using OCC and in accordance with a TDM DMRS sequence, as described herein. In some examples, both of the UEs 115 may communicate using a same cell (e.g., with cell ID u=0).

In some examples, the UEs 115 may not skip one or more TDM DMRSs that would otherwise be lost due to the nulling in accordance with the OCC configuration. For example, the UEs 115 may send TDM DMRS transmissions 705 and may not send nulled TDM DMRS transmissions 710. The UEs 115 may transmit the TDM DMRSs in accordance with a TDM DMRS sequence

$${s}_{u}^{m} ( n ) ,$$

wherein TDM DMRSs are transmitted via DMRS symbols at slot number n, and via cell (e.g., beam) u (e.g., where u=N_{ID}^{cell}mod 16) and a UE m (e.g., where m goes from 0 to M−1). An OCC factor (e.g., a multiplexing order or a quantity of UEs 115 to be multiplexed) may be defined as M (e.g., M=2). In cases where the UE does not skip the TDM DMRSs that would otherwise be lost due to the TDM nulling, the UEs 115 may transmit the DMRSs
via the TDM DMRS sequence

$${s}_{u}^{m} ( n ) = ( x [ {n}^{′} ] {w}_{u} [ {n}^{′} mod 16 ] )$$

( [symbol] {(n mod 2M)>}⊕m), where

$${n}^{′} = n - ⌊ \frac{n}{M} ⌋ - m .$$

In such examples, the UEs 115 may transmit TDM DMRSs that were nulled during next available DMRS symbols.

For example, the UE 115-i may transmit a TDM DMRS corresponding to

$${s}_{u}^{1} ( 0 ) = x [ 0 ]$$

via the DMRS symbol 3, and a TDM DMRS corresponding to

$${s}_{u}^{1} ( 1 ) = x [ 1 ]$$

via the DMRS symbol 10. The UE 115-i may null DMRS transmissions during the DMRS symbol 17 and the DMRS symbol 24 (e.g., based on the OCC codeword configured for the UE 115-i as part of the OCC configuration). The UE 115-i may then transmit the TDM DMRS nulled at the DMRS symbol 17 via the DMRS symbol 31, and may transmit the TDM DMRS nulled at the DMRS symbol 24 via the TDMS symbol 38. For instance, the UE 115-i may transmit the TDM DMRS corresponding to

$${s}_{u}^{1} ( 4 ) = x [ 2 ]$$

via the DMRS symbol 31, and may transmit the TDM DMRS corresponding to

$${s}_{u}^{1} ( 5 ) = x [ 3 ]$$

via the DMRS symbol 38. Similarly, the UE 115-j may transmit the TDM DMRS corresponding to

$${s}_{u}^{2} ( 2 ) = x [ 0 ]$$

via the DMRS symbol 17 and may transmit the TDM DMRS corresponding to

$${s}_{u}^{2} ( 3 ) = x [ 1 ]$$

via the DMRS symbol 24 (e.g., based on the nulled TDM DMRS transmissions 710 in the DMRS symbol 3 and the DMRS symbol 10).

Thus, as described with reference to FIG. 7, the UEs 115 may refrain from transmitting a DMRS during nulled DMRS symbols, but may then transmit the TDM DMRSs in next available (e.g., not nulled) DMRS symbols in accordance with the TDM DMRS sequence. Such techniques may be applied for UEs 115 using the same cell, or using different cells (e.g., as described in greater detail with reference to FIG. 8.

FIG. 8 shows an example of a timeline 800 that supports techniques for TDM DMRSs. The timeline 800 may implement, or be implemented by, aspects of the wireless communication systems 100, the signaling configuration 200, the transmission scheme 300, the timeline 400, the timeline 500, the timeline 600, or the timeline 700. For example, the UE 115-k and the UE 115-1 and a network entity (e.g., a network entity 105), which may be examples of corresponding devices described with reference to FIGS. 1-7, may communicate with each other in accordance with the timeline 800. The UE 115-k and the UE 115-1 may both communicate via a different cell (e.g., the UE 115-k may communicate with a first cell 0 and the UE 115-1 may communicate with a different cell such as cell 4). The UE 115-k and the UE 115-1 may multiplex DMRS transmissions (e.g., via the same DMRS symbols) by using OCC and in accordance with a TDM DMRS sequence, as described herein. The UEs 115 may transmit TDM DMRS transmissions 805, and may null TDM DMRS transmissions 810.

In some examples, the UEs 115 may transmit TDM DMRSs in accordance with a TDM DMRS sequence

$${s}_{u}^{m} ( n ) ,$$

wherein TDM DMRSs are transmitted via DMRS symbols at slot number n, and via cell (e.g., beam) u (e.g., where u=N_{ID}^{cell}mod 16) and a UE m (e.g., where m goes from 0 to M−1). An OCC factor (e.g., a multiplexing order or a quantity of UEs 115 to be multiplexed) may be defined as M. For example, for the UE 115-k and the UE 115-1, M=2.

In some examples, the UE 115-k and the UE 115-1 may use different TDM patterns (e.g., as described in greater detail with reference to FIGS. 5 and 7, where techniques described with reference to a single cell may also be applied for multiple cells). For example, in cases where the TDM pattern is the same, the UEs 115 may be served by different cells (e.g., beams), and in cases where UEs in a same cell are OCCed together may not use the same TDM pattern (e.g., because they will be assigned different codewords by the network entity and the serving cell). In some examples, as illustrated with reference to FIGS. 6 and 8, the UEs 115 may use the same TDM pattern (e.g., may be configured, via control signaling, with the same OCC index value or the same OCC codeword). In such examples, both the UEs 115 may send the same signal. In some examples, the transmissions may not be exactly aligned in time, in which case the timing difference across the different UEs 115 may reduce or mitigate interference at the network entity 105, as described in greater detail with reference to FIG. 6. In some examples, if the signals are closely or exactly aligned in time, then DMRSs transmitted by the UEs 115 may interfere with each other, resulting in corrupted DMRSs. In such examples, the UEs 115 may generate the DMRS sequence using an underlying sequence (e.g., an underlying Gold sequence) which may depend on the cell ID. For example, if the transmitted DMRS signals are aligned in time, then the UE 115-g may generate the DMRS sequence using an underlying sequence that is based on the cell ID for the cell 0, and the UE 115-h may generate the DMRS sequence using an underlying sequence that is based on the cell ID for the cell 4, in which case the resulting DMRS sequences transmitted by the respective UEs 115 may be different, resulting in reduced or mitigated interference at the network entity 105. If the DMRS signals are not aligned, the transmitted sequence may be pseudo-random, and interference cancellation may be performed (e.g., based on the underlying Gold sequences).

As described in greater detail with reference to FIGS. 5 and 7, the UEs 115 may send TDM DMRS transmissions 805 in accordance with the TDM DMRS sequence, and may skip TDM DMRSs corresponding to nulled TDM DMRS transmissions 810. For example, the UE 115-k may refrain from transmitting any nulled TDM DMRSs, such as the nulled TDM DMRS transmission 810 corresponding to

$${s}_{0}^{1} ( 2 ) = x [ 2 ] ,$$

and the nulled TDM DMRS transmission 810 corresponding to

$${s}_{0}^{1} ( 3 ) = x [ 3 ] .$$

In a next available (e.g., non-nulled) DMRS symbol 31, the UE 115-k may transmit a TDM DMRS corresponding to

$${s}_{0}^{1} ( 4 ) = x [ 2 ] ,$$

and during the DMRS symbol 38 the UE 115-k may transmit a TDM DMRS corresponding to

$${s}_{0}^{1} ( 5 ) = x [ 3 ] .$$

Similarly, the UE 115-1 may refrain from transmitting any nulled TDM DMRSs, such as the nulled TDM DMRS transmission 710 corresponding to

$${s}_{2}^{2} ( 2 ) = x [ 2 ] ,$$

and the nulled TDM DMRS transmission 710 corresponding to

$${s}_{2}^{2} ( 3 ) = x [ 3 ] .$$

In a next available (e.g., non-nulled) DMRS symbol 31, the UE 115-1 may transmit a TDM DMRS corresponding to

$${s}_{2}^{2} ( 4 ) = x [ 2 ] ,$$

and during the DMRS symbol 38 the UE 115-1 may transmit a TDM DMRS corresponding to

$${s}_{2}^{2} ( 5 ) = x [ 3 ] .$$

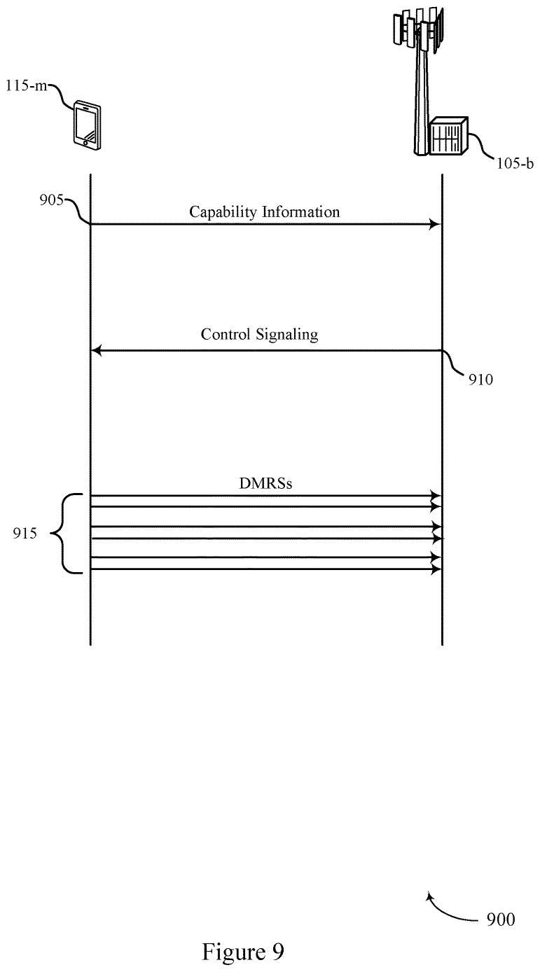

As described in greater detail with reference to FIG. 9, the UEs 115 may transmit capability information indicating that the UEs 115 support multiplexing with OCC. The network entity may configure the UEs 115 with an OCC configuration which may indicate an OCC multiplexing order M and an OCC codeword. The UEs 115 may then transmit TDM DMRSs with OCC in accordance with a TDM DMRS sequence, and may either skip nulled TDM DMRSs (e.g., as described with reference to FIGS. 5 and 6), or may transmit TDM DMRSs that would otherwise be lost due to nulling in next available DMRS symbols in accordance with the TDM DMRS sequence.

FIG. 9 shows an example of a process flow 900 that supports techniques for TDM DMRSs. The process flow 900 may implement, or be implemented by, aspects of the wireless communication system 100, the signaling configuration 200, the transmission scheme 300, the timeline 400, the timeline 500, the timeline 600, the timeline 700, or the timeline 800. For example, the process flow may include the UE 115-m and the network entity 105-b, which may be examples of corresponding devices described with reference to FIGS. 1-8. In some examples, the UE 115-m may be an NB-IoT UE, and the network entity 105 may be an NTN network entity.

At 905, the UE 115-m may transmit capability information. The capability information may indicate that the UE 115-m supports multiplexing of uplink transmissions with OCCs. In some examples, the capability for multiplexing may depend on a phase coherence capability (e.g., phase coherence requirements) associated with the UE 115-m.

At 910, the UE 115-m may receive control signaling (e.g., from the network entity 105-b). The control signaling may include an OCC configuration, which may include a multiplexing order (e.g., M), and a codeword (e.g., m) for TDM DMRSs. The control signaling may be RRC signaling, Downlink Control information (DCI) or a MAC-CE, in some examples, indicating specific details regarding the DMRS configuration to be used.

In some examples, the wireless communication system may support multiple candidate TDM DMRS transmission schemes (e.g., multiple candidate TDM DMRS sequences or DMRS designs). For instance, in accordance with a first candidate sequence, the UE 115-m may skip lost TDM DMRSs. In accordance with a second candidate sequence, the UE 115-m may not skip TDM DMRSs that would be lost due to TDM DMRS nulling, and may instead transmit such TDM DMRSs via a next available DMRS slot in a next slot. In such examples, the control signaling may indicate which candidate scheme, or which TDM DMRS sequence, the UE 115-m is to use. In such examples, transmission of the TDM DMRS sequence at 915 may be based on the indication of which sequence to use.

At 915, the UE 115-m may transmit a sequence of TDM DMRSs via a set of slots based at least in part on the multiplexing order M and a codeword m. Transmission of the sequence of TDM DMRSs may include nulling one or more TDM DMRS transmissions in a first subset of slots. In some examples, as described in greater detail with reference to FIGS. 5 and 6, the UE 115-m may skip a subset of DMRSs corresponding to the one or more nulled TDM DMRS transmissions in accordance with the sequence. In some examples, as described in greater detail with reference to FIGS. 7 and 8, the UE 115-m may transmit at least a portion of the subset of DMRSs corresponding to the one or more nulled TDM DMRS transmissions (e.g., the TDM DMRSs that were not transmitted during nulled DMRS symbols) via one or more of the second subset of slots (e.g., via a next available DMRS symbol of a next available slot) in accordance with the sequence. The UE 115-m may select the DMRS symbols and corresponding slots (e.g., the second subset of slots) for transmitting DMRSs and DMRS symbols and corresponding slots (e.g., the first set of slots) for nulling DMRS transmissions based on the codeword indicated at 910. The UE 115-m may also generate the sequence of TDM DMRSs for the first subset of slots and the second subset of slots based on a defined sequence generation pattern (e.g., which may be defined in one or more standards documents or indicated via control signaling).

In some examples, the UE 115-m may identify multiple input values (e.g., wᵤ[n] for a given cell ID u) for the sequence, each input value corresponding to a respective slot. The cases in which the UE 115-m skips lost TDM DMRSs, the UE 115-m may transmit TDM DMRSs (e.g., a second subset of DMRSs) via the second subset of slots in accordance with the TDM DMRS sequence, where the second subset of DMRSs are based on a first portion of the input values (e.g., the TDM DMRSs corresponding to the TDM DMRS transmissions in non-nulled DMRS symbols). The UE 115-m may skip the subset of DMRSs corresponding to the first subset of slots (e.g., the nulled DMRS symbols in the first subset of slots), and may refrain from transmitting the subset of DMRSs that are based on a second portion of the input values (e.g., TDM DMRSs that were not transmitted during the nulled DMRS symbols may not be transmitted at all).

In some cases, the UE 115-m may generate a first DMRS of the subset of DMRSs corresponding to the first subset of slots using a first input value corresponding to a first slot of the first subset of slots (e.g., the UE 115-m may generate TDM DMRSs for nulled DMRS symbols) and may transmit the first DMRS corresponding to the first input value via a next available slot of the second subset of slots based on having nulled a DMRS symbol corresponding to the first DMRS. For instance, having nulled a DMRS symbol, the UE 115-m may transmit the DMRS that would have otherwise been lost due to the TDM via a next DMRS symbol that is not nulled.

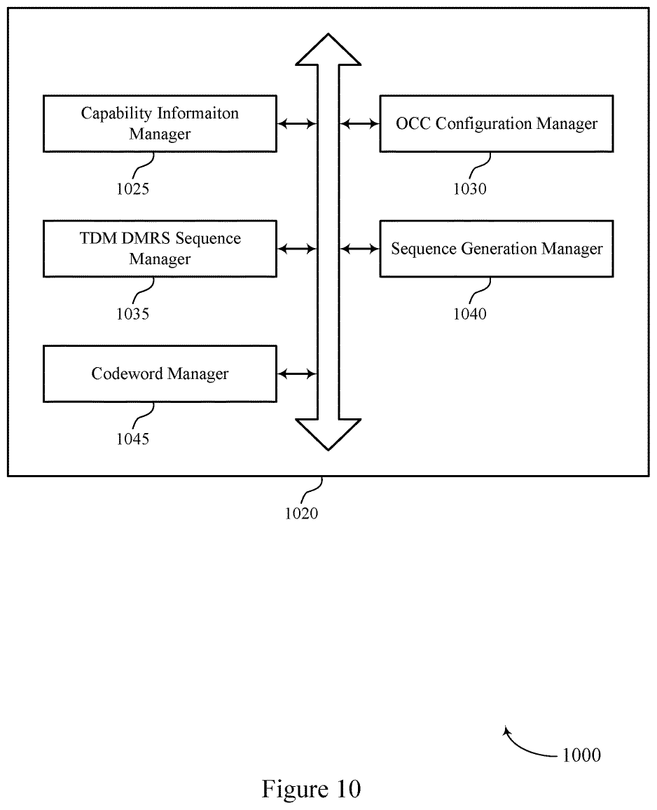

FIG. 10 shows an example of a processing system 1020 that supports techniques for TDM DMRSs. A processing system 1020 may be an example of a processing system 140 (such as of a UE 115) and may include a capability information manager 1025, an OCC configuration manager 1030, a TDM DMRS sequence manager 1035, a sequence generation manager 1040, a codeword manager 1045, or any combination thereof. A processing system 1020, or various component thereof, may be an example of means for performing (such as a means for causing a UE 115 to perform) various techniques described herein.

The capability information manager 1025 may be configured to cause the UE 115 to transmit capability information indicating that the UE supports multiplexing of uplink transmissions with orthogonal cover codes (OCCs). The OCC configuration manager 1030 may be configured to cause the UE 115 to receive control signaling including an OCC configuration, the OCC configuration including a multiplexing order and a codeword for time domain multiplexed (TDM) demodulation reference signals (DMRSs). The TDM DMRS sequence manager 1035 may be configured to cause the UE 115 to transmit a sequence of TDM DMRSs via a set of slots based on the multiplexing order and the codeword, where transmission of the sequence of TDM DMRSs includes nulling one or more TDM DMRS transmissions in a first subset of the set of slots, where the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence.

In some examples, the sequence generation manager 1040 may be configured to cause the UE 115 to identify a set of multiple input values for the sequence, each input value corresponding to a respective slot of a set of multiple slots including the first subset of slots and the second subset of slots. In some examples, the TDM DMRS sequence manager 1035 may be configured to cause the UE 115 to transmit a second subset of DMRSs via the second subset of slots in accordance with the sequence, the second subset of DMRSs based on a first portion of the set of multiple input values corresponding to the second subset of slots, where skipping the subset of DMRSs corresponding to the first subset of slots includes refraining from transmitting the subset of DMRSs that are based on a second portion of the set of multiple input values corresponding to the first subset of slots.

In some examples, the sequence generation manager 1040 may be configured to cause the UE 115 to identify a set of multiple input values for the sequence, each input value corresponding to a respective slot of a set of multiple slots including the first subset of slots and the second subset of slots. In some examples, the TDM DMRS sequence manager 1035 may be configured to cause the UE 115 to generate a first DMRS of the subset of DMRSs corresponding to the first subset of slots using a first input value corresponding to a first slot of the first subset of slots. In some examples, the TDM DMRS sequence manager 1035 may be configured to cause the UE 115 to transmit the first DMRS corresponding to the first input value via a next available slot of the second subset of slots based on nulling the first slot of the first subset of slots.

In some examples, the sequence generation manager 1040 may be configured to cause the UE 115 to generate the sequence of TDM DMRSs for the first subset of slots and the second subset of slots based on a defined sequence generation pattern, the codeword, and the multiplexing order.

In some examples, the codeword manager 1045 may be configured to cause the UE 115 to select the first subset of slots for transmission of the sequence of TDM DMRSs and the second subset of slots for transmission of the sequence of TDM DMRSs in accordance with the codeword.

In some examples, the capability information is based on a capability of the UE to maintain phase coherence for the supporting of multiplexing of uplink transmissions with OCC.

In some examples, the control signaling includes an indication of whether the UE is to skip the subset of DMRSs corresponding to the first subset of slots in accordance with the sequence, or transmit at least the portion of the subset of DMRSs corresponding to the first subset of slots via the second subset of slots in accordance with the sequence.

In some examples, the UE includes a narrowband internet of things (NB-IoT) UE.

In some examples, the UE is served by a non-terrestrial network (NTN) network entity.

A processing system 1020 may include or be a component of one or more chips, systems-on-chips (SoCs), chipsets, packages, components, or devices that individually or collectively constitute or include a processing system. A processing system 1020 may interface with other components of a processing system 1020. For example, operations described with reference to a processing system 1020, or various components thereof, may be performed by or with other such components, including a receiver, a transmitter, a transceiver, a modem, a user interface, a modulator/demodulator, an encoder/decoder, or any combination thereof (such as of the processing system 1020, coupled with the processing system 1020, of a processing system 1020).

By including or configuring a processing system 1020 for operation in a system or a device (e.g., such as a UE 115) as described herein, the processing system 1020 may support techniques for TDM DMRS transmissions with OCC according to a TDM DMRS sequence resulting in improved throughput, accurate channel estimation, more efficient use of available system resources, and reduced processing.

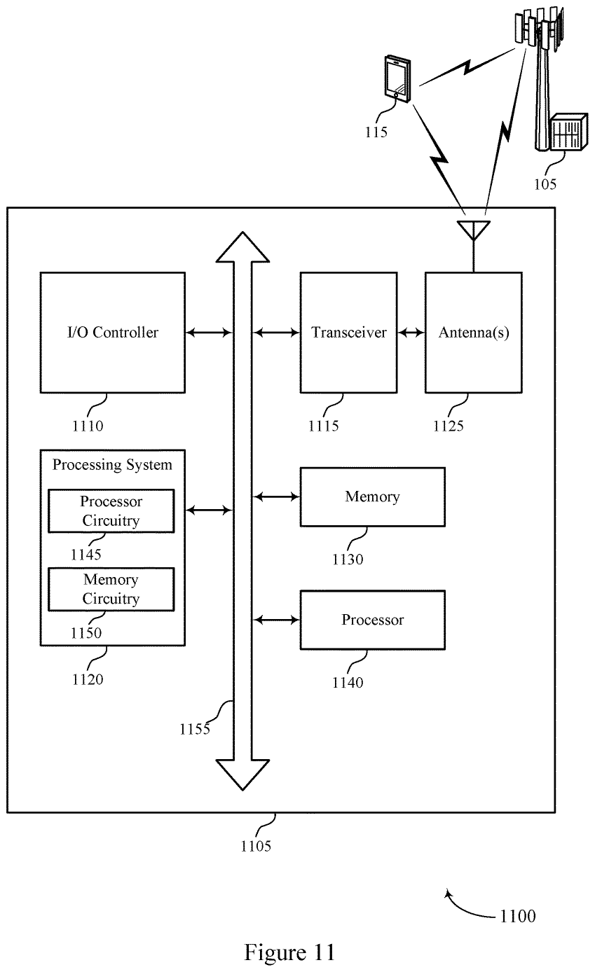

FIG. 11 shows an example of a system 1100 including a device 1105 that supports techniques for TDM DMRSs. The device 1105 may be an example of or include components of UE 115. The device 1105 may communicate (such as wirelessly) with one or more other devices (such as network entities 105, UEs 115). The device 1105 may include components for transmitting and receiving communication, which may include a processing system 1120, an input/output (I/O) controller, such as an I/O controller 1110, a transceiver 1115, antenna(s) 1125, a memory 1130, and a processor 1140. Components of the device 1105 may be coupled (such as operatively, communicatively, functionally, electronically, electrically, in electronic communication) a bus 1155.

The transceiver 1115 may support bi-directional communication via antenna(s) 1125, and may support transmission operations, reception operations, or both, as described herein. The transceiver 1115 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 1105). The transceiver 1115 may modulate symbols and provide the modulated symbols to antenna(s) 1125 for transmission, and demodulate symbols from signals received using antenna(s) 1125.

The processor 1140 may be a general-purpose processing component that supports various operations (such as applications) of the device 1105. The memory 1130 may be a general-purpose storage component that stores code executable by the processor 1140. Such code may include instructions that, when executed by the processor 1140, cause the device 1105 to perform various functions (such as to support an application of the device 1105). The I/O controller 1110 may manage inputs and outputs for the device 1105, may manage peripherals not integrated into the device 1105, or may represent a physical connection (such as port) to an external peripheral. The processor 1140 may interact with a modem, a keyboard, a mouse, a touchscreen, or other device (such as via I/O controller 1110). In some implementations, a user may interact with the device 1105 via the I/O controller 1110 or via hardware components controlled by the I/O controller 1110.

The processing system 1120 may be an example of a processing system 140 or a processing system 1020. For example, the processing system 1120 may include processor circuitry 1145 and memory circuitry 1150 that stores code, and may be configured to cause the device 1105 to perform operations that support techniques for TDM DMRSs. Although the processing system 1120 is illustrated as a separate component, which may involve a separate chip, chipset, or other module, in some implementations, one or more functions described with reference to the processing system 1120 may be supported by or performed by a transceiver 1115, antenna(s) 1125, a processor 1140, memory 1130, or any combination thereof, such that a processing system 1120 may include one or more of a transceiver 1115, antenna(s) 1125, a processor 1140, memory 1130, or any combination thereof.

By including or configuring the processing system 1120 for operation in the device 1105 as described herein, may support techniques for TDM DMRS transmissions with OCC according to a TDM DMRS sequence resulting in improved throughput, accurate channel estimation, more efficient use of available system resources, improved coordination between devices and reduced processing.

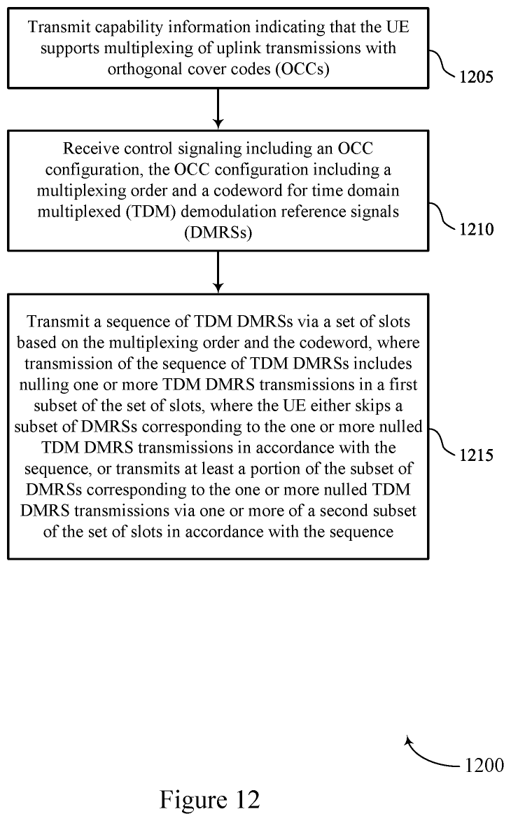

FIG. 12 shows an example of a method 1200 that supports techniques for TDM DMRSs. Operations of the method 1200 may be performed by a UE or its components (such as using a processing system configured to cause the UE 115 to perform one or more of the operations) as described herein.

At 1205, the method may include transmitting capability information indicating that the UE supports multiplexing of uplink transmissions with orthogonal cover codes (OCCs). In some examples, aspects of the operations of 1205 may be performed by a capability information manager 1025.

At 1210, the method may include receiving control signaling including an OCC configuration, the OCC configuration including a multiplexing order and a codeword for time domain multiplexed (TDM) demodulation reference signals (DMRSs). In some examples, aspects of the operations of 1210 may be performed by an OCC configuration manager 1030.

At 1215, the method may include transmitting a sequence of TDM DMRSs via a set of slots based on the multiplexing order and the codeword, where transmission of the sequence of TDM DMRSs includes nulling one or more TDM DMRS transmissions in a first subset of the set of slots, where the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence. In some examples, aspects of the operations of 1215 may be performed by a TDM DMRS sequence manager 1035.

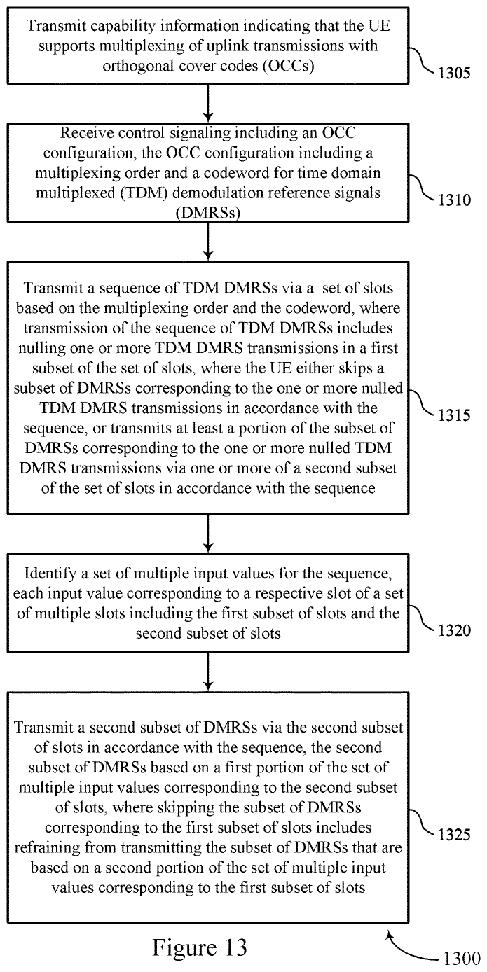

FIG. 13 shows an example of a method 1300 that supports techniques for TDM DMRSs. Operations of the method 1300 may be performed by a UE or its components (such as using a processing system configured to cause the UE 115 to perform one or more of the operations) as described herein.

At 1305, the method may include transmitting capability information indicating that the UE supports multiplexing of uplink transmissions with orthogonal cover codes (OCCs). In some examples, aspects of the operations of 1305 may be performed by a capability information manager 1025.

At 1310, the method may include receiving control signaling including an OCC configuration, the OCC configuration including a multiplexing order and a codeword for time domain multiplexed (TDM) demodulation reference signals (DMRSs). In some examples, aspects of the operations of 1310 may be performed by an OCC configuration manager 1030.

At 1315, the method may include transmitting a sequence of TDM DMRSs via a set of slots based on the multiplexing order and the codeword, where transmission of the sequence of TDM DMRSs includes nulling one or more TDM DMRS transmissions in a first subset of the set of slots, where the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence. In some examples, aspects of the operations of 1315 may be performed by a TDM DMRS sequence manager 1035.

At 1320, the method may include identifying a set of multiple input values for the sequence, each input value corresponding to a respective slot of a set of multiple slots including the first subset of slots and the second subset of slots. In some examples, aspects of the operations of 1320 may be performed by a sequence generation manager 1040.

At 1325, the method may include transmitting a second subset of DMRSs via the second subset of slots in accordance with the sequence, the second subset of DMRSs based on a first portion of the set of multiple input values corresponding to the second subset of slots, where skipping the subset of DMRSs corresponding to the first subset of slots includes refraining from transmitting the subset of DMRSs that are based on a second portion of the set of multiple input values corresponding to the first subset of slots. In some examples, aspects of the operations of 1325 may be performed by a TDM DMRS sequence manager 1035.

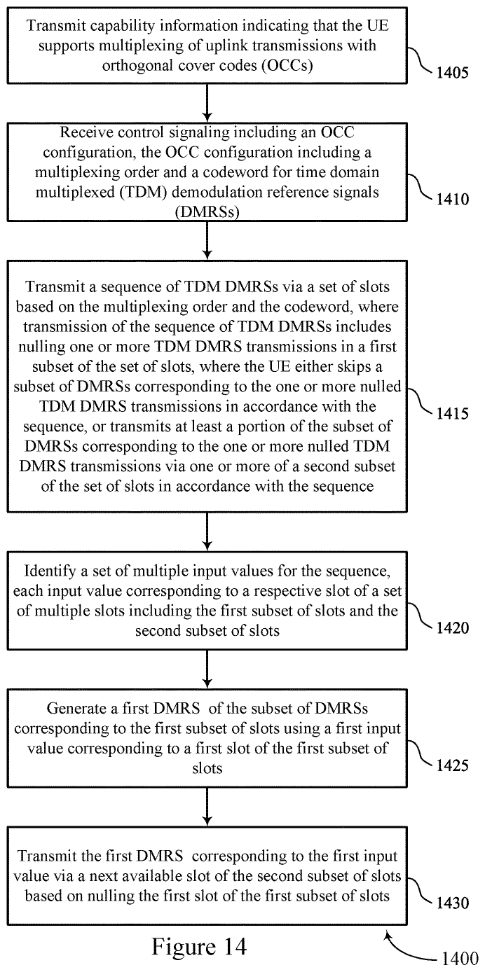

FIG. 14 shows an example of a method 1400 that supports techniques for TDM DMRSs. Operations of the method 1400 may be performed by a UE or its components (such as using a processing system configured to cause the UE 115 to perform one or more of the operations) as described herein.

At 1405, the method may include transmitting capability information indicating that the UE supports multiplexing of uplink transmissions with orthogonal cover codes (OCCs). In some examples, aspects of the operations of 1405 may be performed by a capability information manager 1025.

At 1410, the method may include receiving control signaling including an OCC configuration, the OCC configuration including a multiplexing order and a codeword for time domain multiplexed (TDM) demodulation reference signals (DMRSs). In some examples, aspects of the operations of 1410 may be performed by an OCC configuration manager 1030.

At 1415, the method may include transmitting a sequence of TDM DMRSs via a set of slots based on the multiplexing order and the codeword, where transmission of the sequence of TDM DMRSs includes nulling one or more TDM DMRS transmissions in a first subset of the set of slots, where the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence. In some examples, aspects of the operations of 1415 may be performed by a TDM DMRS sequence manager 1035.

At 1420, the method may include identifying a set of multiple input values for the sequence, each input value corresponding to a respective slot of a set of multiple slots including the first subset of slots and the second subset of slots. In some examples, aspects of the operations of 1420 may be performed by a sequence generation manager 1040.

At 1425, the method may include generating a first DMRS of the subset of DMRSs corresponding to the first subset of slots using a first input value corresponding to a first slot of the first subset of slots. In some examples, aspects of the operations of 1425 may be performed by a TDM DMRS sequence manager 1035.

At 1430, the method may include transmitting the first DMRS corresponding to the first input value via a next available slot of the second subset of slots based on nulling the first slot of the first subset of slots. In some examples, aspects of the operations of 1430 may be performed by a TDM DMRS sequence manager 1035.

Implementation examples are described in the following numbered clauses:

Aspect 1: A method for wireless communications at a UE, comprising: transmitting capability information indicating that the UE supports multiplexing of uplink transmissions with orthogonal cover codes (OCCs); receiving control signaling including an OCC configuration, the OCC configuration including a multiplexing order and a codeword for time domain multiplexed (TDM) demodulation reference signals (DMRSs); and transmitting a sequence of TDM DMRSs via a set of slots based at least in part on the multiplexing order and the codeword, wherein transmission of the sequence of TDM DMRSs comprises nulling one or more TDM DMRS transmissions in a first subset of the set of slots, wherein the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence.

Aspect 2: The method of aspect 1, further comprising: identifying a plurality of input values for the sequence, each input value corresponding to a respective slot of the set of slots comprising the first subset of slots and the second subset of slots; and transmitting a second subset of DMRSs via the second subset of slots in accordance with the sequence, the second subset of DMRSs based at least in part on a first portion of the plurality of input values corresponding to the second subset of slots, wherein skipping the subset of DMRSs corresponding to the first subset of slots comprises refraining from transmitting the subset of DMRSs that are based at least in part on a second portion of the plurality of input values corresponding to the first subset of slots.

Aspect 3: The method of any of aspects 1 through 2, further comprising: identifying a plurality of input values for the sequence, each input value corresponding to a respective slot of a plurality of slots comprising the first subset of slots and the second subset of slots; generating a first DMRS of the subset of DMRSs corresponding to the first subset of slots using a first input value corresponding to a first slot of the first subset of slots; and transmitting the first DMRS corresponding to the first input value via a next available slot of the second subset of slots based at least in part on nulling the first slot of the firstsubset of slots.

Aspect 4: The method of any of aspects 1 through 3, further comprising: generating the sequence of TDM DMRSs for the first subset of slots and the second subset of slots based at least in part on a defined sequence generation pattern, the codeword, and the multiplexing order.

Aspect 5: The method of any of aspects 1 through 4, further comprising: selecting the first subset of slots for transmission of the sequence of TDM DMRSs and the second subset of slots for transmission of the sequence of TDM DMRSs in accordance with the codeword.

Aspect 6: The method of any of aspects 1 through 5, wherein the capability information is based at least in part on a capability of the UE to maintain phase coherence for the supporting of multiplexing of uplink transmissions with OCC.

Aspect 7: The method of any of aspects 1 through 6, wherein the control signaling includes an indication of whether the UE is to skip the subset of DMRSs corresponding to the first subset of slots in accordance with the sequence, or transmit at least the portion of the subset of DMRSs corresponding to the first subset of slots via the second subset of slots in accordance with the sequence.

Aspect 8: The method of any of aspects 1 through 7, wherein the UE comprises a narrowband internet of things (NB-IoT) UE.

Aspect 9: The method of any of aspects 1 through 8, wherein the UE is served by a non-terrestrial network (NTN) network entity.

Aspect 10: A UE for wireless communications, comprising a processing system that includes processor circuitry and memory circuitry that stores code, the processing system configured to cause the UE to perform a method of any of aspects 1 through 9.

Aspect 11: A UE for wireless communications, comprising at least one means for performing a method of any of aspects 1 through 9.

Aspect 12: A non-transitory computer-readable medium storing code for wireless communications, the code comprising instructions executable by one or more processors to perform a method of any of aspects 1 through 9.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit capability information indicating that the UE supports multiplexing of uplink transmissions with orthogonal cover codes (OCCs);
receive control signaling including an OCC configuration, the OCC configuration including a multiplexing order and a codeword for a sequence of time domain multiplexed (TDM) demodulation reference signals (DMRSs); and
transmit a sequence of TDM DMRSs via a set of slots based at least in part on the multiplexing order and the codeword, wherein transmission of the sequence of TDM DMRSs comprises nulling one or more TDM DMRS transmissions in a first subset of the set of slots, wherein the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence.

2. The UE of claim 1, wherein the one or more processors are individually or collectively further operable to execute the code to cause the UE to:
identify a plurality of input values for the sequence, each input value corresponding to a respective slot of the set of slots comprising the first subset of slots and the second subset of slots; and
transmit a second subset of DMRSs via the second subset of slots in accordance with the sequence, the second subset of DMRSs based at least in part on a first portion of the plurality of input values corresponding to the second subset of slots, wherein skipping the subset of DMRSs corresponding to the first subset of slots comprises refraining from transmitting the subset of DMRSs that are based at least in part on a second portion of the plurality of input values corresponding to the first subset of slots.

3. The UE of claim 1, wherein the one or more processors are individually or collectively further operable to execute the code to cause the UE to:
identify a plurality of input values for the sequence, each input value corresponding to a respective slot of the set of slots comprising the first subset of slots and the second subset of slots;
generate a first DMRS of the subset of DMRSs corresponding to the first subset of slots using a first input value corresponding to a first slot of the first subset of slots; and
transmit the first DMRS corresponding to the first input value via a next available slot of the second subset of slots based at least in part on nulling the first slot of the first subset of slots.

4. The UE of claim 1, wherein the one or more processors are individually or collectively further operable to execute the code to cause the UE to:
generate the sequence of TDM DMRSs for the first subset of slots and the second subset of slots based at least in part on a defined sequence generation pattern, the codeword, and the multiplexing order.

5. The UE of claim 1, wherein the one or more processors are individually or collectively further operable to execute the code to cause the UE to:
select the first subset of slots for transmission of the sequence of TDM DMRSs and the second subset of slots for transmission of the sequence of TDM DMRSs in accordance with the codeword.

6. The UE of claim 1, wherein the capability information is based at least in part on a capability of the UE to maintain phase coherence for the supporting of multiplexing of uplink transmissions with OCC.

7. The UE of claim 1, wherein the control signaling includes an indication of whether the UE is to skip the subset of DMRSs corresponding to the first subset of slots in accordance with the sequence, or transmit at least the portion of the subset of DMRSs corresponding to the first subset of slots via the second subset of slots in accordance with the sequence.

8. The UE of claim 1, wherein the UE comprises a narrowband internet of things (NB-IoT) UE.

9. The UE of claim 1, wherein the UE is served by a non-terrestrial network (NTN) network entity.

10. A method for wireless communications at a user equipment (UE), comprising:
transmitting capability information indicating that the UE supports multiplexing of uplink transmissions with orthogonal cover codes (OCCs);
receiving control signaling including an OCC configuration, the OCC configuration including a multiplexing order and a codeword for time domain multiplexed (TDM) demodulation reference signals (DMRSs); and
transmitting a sequence of TDM DMRSs via a set of slots based at least in part on the multiplexing order and the codeword, wherein transmission of the sequence of TDM DMRSs comprises nulling one or more TDM DMRS transmissions in a first subset of the set of slots, wherein the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence.

11. The method of claim 10, further comprising:
identifying a plurality of input values for the sequence, each input value corresponding to a respective slot of the set of slots comprising the first subset of slots and the second subset of slots; and
transmitting a second subset of DMRSs via the second subset of slots in accordance with the sequence, the second subset of DMRSs based at least in part on a first portion of the plurality of input values corresponding to the second subset of slots, wherein skipping the subset of DMRSs corresponding to the first subset of slots comprises refraining from transmitting the subset of DMRSs that are based at least in part on a second portion of the plurality of input values corresponding to the first subset of slots.

12. The method of claim 10, further comprising:
identifying a plurality of input values for the sequence, each input value corresponding to a respective slot of the set of slots comprising the first subset of slots and the second subset of slots;
generating a first DMRS of the subset of DMRSs corresponding to the first subset of slots using a first input value corresponding to a first slot of the first subset of slots; and
transmitting the first DMRS corresponding to the first input value via a next available slot of the second subset of slots based at least in part on nulling the first slot of the first subset of slots.

13. The method of claim 10, further comprising:
generating the sequence of TDM DMRSs for the first subset of slots and the second subset of slots based at least in part on a defined sequence generation pattern, the codeword, and the multiplexing order.

14. The method of claim 10, further comprising:
selecting the first subset of slots for transmission of the sequence of TDM DMRSs and the second subset of slots for transmission of the sequence of TDM DMRSs in accordance with the codeword.

15. The method of claim 10, wherein the capability information is based at least in part on a capability of the UE to maintain phase coherence for the supporting of multiplexing of uplink transmissions with OCC.

16. The method of claim 10, wherein the control signaling includes an indication of whether the UE is to skip the subset of DMRSs corresponding to the first subset of slots in accordance with the sequence, or transmit at least the portion of the subset of DMRSs corresponding to the first subset of slots via the second subset of slots in accordance with the sequence.

17. The method of claim 10, wherein the UE comprises a narrowband internet of things (NB-IoT) UE.

18. The method of claim 10, wherein the UE is served by a non-terrestrial network (NTN) network entity.

19. A user equipment (UE) for wireless communications, comprising:
means for transmitting capability information indicating that the UE supports multiplexing of uplink transmissions with orthogonal cover codes (OCCs);
means for receiving control signaling including an OCC configuration, the OCC configuration including a multiplexing order and a codeword for time domain multiplexed (TDM) demodulation reference signals (DMRSs); and
means for transmitting a sequence of TDM DMRSs via a set of slots based at least in part on the multiplexing order and the codeword, wherein transmission of the sequence of TDM DMRSs comprises nulling one or more TDM DMRS transmissions in a first subset of the set slots, wherein the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence.

20. A non-transitory computer-readable medium storing code for wireless communications, the code comprising instructions executable by one or more processors to:
transmit capability information indicating that a user equipment (UE) supports multiplexing of uplink transmissions with orthogonal cover codes (OCCs);
receive control signaling including an OCC configuration, the OCC configuration including a multiplexing order and a codeword for time domain multiplexed (TDM) demodulation reference signals (DMRSs); and
transmit a sequence of TDM DMRSs via a set of slots based at least in part on the multiplexing order and the codeword, wherein transmission of the sequence of TDM DMRSs comprises nulling one or more TDM DMRS transmissions in a first subset of the set of slots, wherein the UE either skips a subset of DMRSs corresponding to the one or more nulled TDM DMRS transmissions in accordance with the sequence, or transmits at least a portion of the subset of DMRSs corresponding to the one or more nulled TDM DMRS transmissions via one or more of a second subset of the set of slots in accordance with the sequence.
